(19) United States
(12) Patent Application Publication
(10) Pub. No.: US 2011/0292543 A1
(43) Pub. Date: Dec. 1, 2011

(54) HEAD GIMBAL ASSEMBLY AND DISK DRIVE WITH THE SAME

(75) Inventor: Koji Miyake, Tokyo (JP)

(73) Assignee: Kabushiki Kaisha Toshiba, Tokyo (JP)

(21) Appl. No.: 13/021,741

(22) Filed: Feb. 5, 2011

(30) Foreign Application Priority Data
May 28, 2010 (JP) 2010-123534

(51) Int. Cl. G11B 5/48; G11B 17/028

(52) U.S. Cl. 360/99.08; 360/245.3; 360/244.2; G9B/17.006; G9B/5.153

(57) ABSTRACT

According to one embodiment, a head gimbal assembly includes a suspension includes a load beam and a gimbal, a slider includes a head and mounted on the gimbal, a gap portion defined between the gimbal and the slider, in an area where the gimbal and an air inflow end of the slider overlap each other, and configured to accommodate contamination.

### CROSS-REFERENCE TO RELATED APPLICATIONS

This application is based upon and claims the benefit of priority from Japanese Patent Application No. 2010-123534, filed May 28, 2010; the entire contents of which are incorporated herein by reference.

### FIELD

Embodiments described herein relate to a head gimbal assembly used in a disk drive and the disk drive provided with the same.

### BACKGROUND

In recent years, disk drives, such as magnetic disk drives, optical disc drives, etc., have become widely used as external recording devices of computers and image recording devices.

In general, a disk drive, e.g., a magnetic disk drive, comprises a magnetic disk in a case, spindle motor configured to support and rotate the disk, head actuator that supports magnetic heads, voice coil motor (VCM) for driving the head actuator, circuit board unit, etc.

The head actuator comprises a bearing unit and a plurality of arms laminated to the bearing unit and extending from the bearing unit. A magnetic head is mounted on each arm by means of a suspension. The magnetic head comprises a slider and head section (recording/reproduction element) on the slider and is supported on the suspension by a gimbal spring. The magnetic head, the gimbal spring, the suspension, a conductor trace connected to the head, and in some cases, the arm constitute a head gimbal assembly.

In the magnetic disk drive constructed in this manner, contamination produced therein is carried by internal airflow and some dust is accumulated near a region of contact between the inflow end of the slider and the gimbal spring. This is done because a stagnation point where the flow rate of airflow is approximately zero is formed near the contact region. The accumulated dust may drop onto the disk and permeate between the head and disk during a head loading/unloading operation or other operation. In such a case, the head or disk may be seriously damaged.

### BRIEF DESCRIPTION OF THE DRAWINGS

A general architecture that implements the various feature of the invention will now be described with reference to the drawings. The drawings and the associated descriptions are provided to illustrate embodiments and not to limit the scope of the invention.

FIG. 1 is an exemplary perspective view showing an HDD according to a first embodiment with its top cover removed;

FIG. 2 is an exemplary perspective view showing a head stack assembly of the HDD;

FIG. 3 is an exemplary plan view showing a head gimbal assembly of the head stack assembly;

FIG. 4 is an exemplary enlarged plan view showing a magnetic head and gimbal spring of the head gimbal assembly;

FIG. 5 is an exemplary sectional view of the distal end portion of the gimbal assembly taken along line V-V of FIG. 4;

FIG. 6 is an exemplary enlarged plan view showing a head of a head gimbal assembly of an HDD according to a second embodiment and its surroundings;

FIG. 7 is an exemplary sectional view of the distal end portion of the gimbal assembly taken along line VII-VII of FIG. 6;

FIG. 8 is an exemplary enlarged plan view showing a head of a head gimbal assembly of an HDD according to a third embodiment and its surroundings;

FIG. 9 is an exemplary sectional view of the distal end portion of the gimbal assembly taken along line IX-IX of FIG. 8;

FIG. 10 is an exemplary enlarged plan view showing a head of a head gimbal assembly of an HDD according to a fourth embodiment and its surroundings; and

FIG. 11 is an exemplary enlarged plan view showing a head of a head gimbal assembly of an HDD according to a fifth embodiment and its surroundings.

### DETAILED DESCRIPTION

Various embodiments will be described hereinafter with reference to the accompanying drawings.

In general, according to one embodiment, a head gimbal assembly comprises a suspension comprising a load beam and a gimbal; a slider comprising a head and mounted on the gimbal; a gap portion defined between the gimbal and the slider, in an area where the gimbal and an air inflow end of the slider overlap each other, and configured to accommodate contamination.

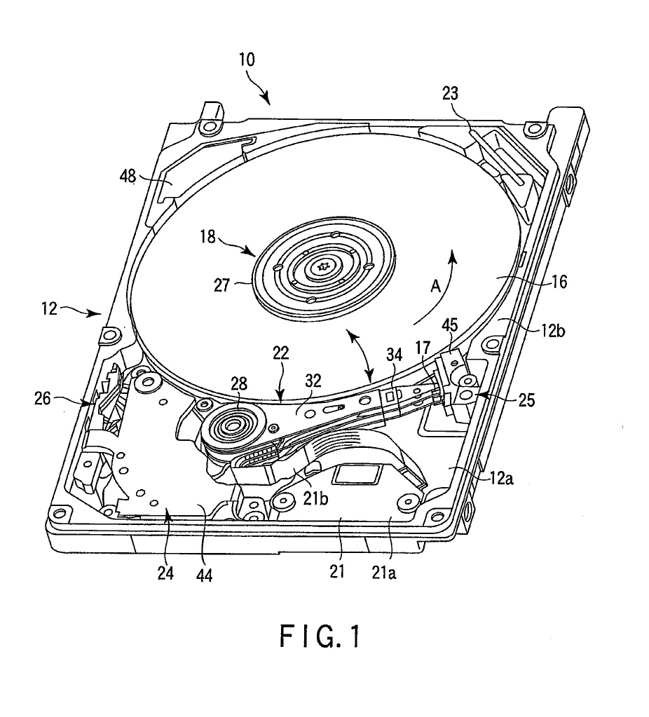

A magnetic disk drive (HDD) according to a first embodiment will now be described in detail with reference to the accompanying drawings. FIG. 1 shows the internal structure of the HDD with its top cover removed. As shown in FIG. 1, the HDD comprises a housing 10. The housing 10 comprises a base 12 in the form of an open-topped rectangular box and a top cover (not shown), which is attached to the base by screws so as to close the top opening of the base. The base 12 comprises a rectangular bottom wall 12a and sidewall 12b set up along the peripheral edge of bottom wall.

The housing 10 contains two magnetic disks 16 for use as recording media and a spindle motor 18 for use as a drive section that supports and rotates the magnetic disks 16. The spindle motor 18 is disposed on the bottom wall 12a. Each magnetic disk 16 has a diameter of, for example, 65 mm (2.5 inches) and comprises magnetic recording layers on its upper and lower surfaces, individually. The magnetic disks 16 are coaxially fitted on a hub (not shown) of the spindle motor 18 and clamped and secured to the hub by a clamp spring 27. Thus, the magnetic disks 16 are supported parallel to the bottom wall 12a of the base 12. The disks 16 are rotated at a predetermined speed, e.g., 5,400 or 7,200 rpm, by the spindle motor 18.

The housing 10 contains a plurality of magnetic heads 17, head stack assembly (HSA) 22, and voice coil motor (VCM) 24. The magnetic heads record and reproduce data on and from the magnetic disks 16. The HSA 22 supports the heads 17 for movement relative to the disks 16. The VCM 24 pivots and positions the HSA. The housing 10 further contains a ramp loading mechanism 25, latch mechanism 26, and board unit 21. The ramp loading mechanism 25 holds the magnetic heads 17 in a retracted position off the magnetic disks 16 when the heads are moved to the outermost peripheries of the disks. The latch mechanism 26 holds the HSA in its retracted position if the HDD is jolted. The board unit 21 comprises a preamplifier and the like.

A printed circuit board (not shown) is attached to the outer surface of the bottom wall 12a of the base 12 by screws. This circuit board controls the operations of the spindle motor 18, VCM 24, and magnetic heads 17 through the board unit 21. A circulatory filter 23 that traps dust produced in the housing 10 as a movable part or parts are operated is disposed on the sidewall of the base 12. The filter 23 is located outside the magnetic disks 16. Likewise, a breather filter 48 that traps dust in the external air introduced into the housing 10 is disposed on the sidewall of the base 12.

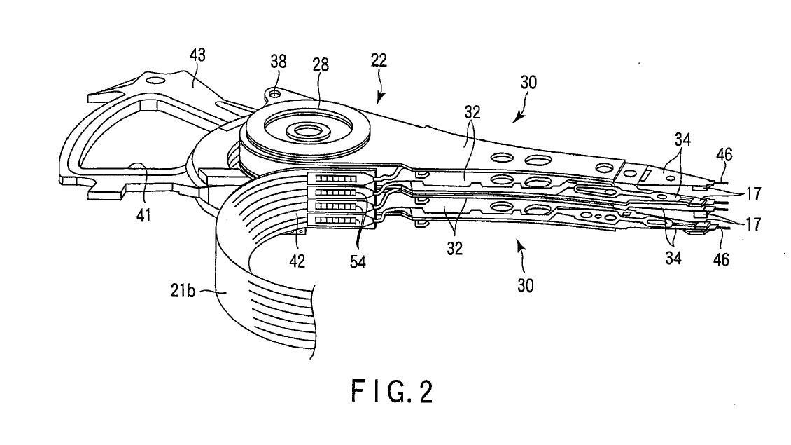

FIG. 2 is an exemplary perspective view of the HSA 2. As shown in FIGS. 1 and 2, the HSA 22 comprises a rotatable bearing unit 28 and a plurality of stack members mounted in layers on the bearing unit 28. The stack members include four head gimbal assemblies (HGAs) 30 and two spacer rings sandwiched between the HGAs.

The bearing unit 28 is located at a distance from the center of rotation of the magnetic disks 16 longitudinally relative to the base 12 and near the outer peripheral edges of the disks 16. The bearing unit 28 comprises a pivot set up on the bottom wall 12a of the base 12 and a cylindrical sleeve rotatably supported on the pivot by bearings.

As shown in FIGS. 1 to 3, each HGA 30 comprises an arm 32, a suspension 34 extending from the arm, and one of the magnetic heads 17 supported on the extended end of the suspension by a gimbal.

The arm 32 is a thin flat plate formed by laminating, for example, stainless-steel, aluminum, and stainless-steel sheets. A circular through-hole is formed in one end or proximal end of the arm 32. The suspension 34 comprises a load beam 34a in the form of an elongated plate spring and a gimbal 36 (described later) mounted on the load beam. The suspension 34 has its proximal end secured to the distal end of the arm 32 by spot welding or adhesive bonding and extends from the arm. The suspension 34 and arm 32 may be integrally formed of the same material. The HGA may be a concept that does not include an arm.

A relay flexible printed circuit board (relay FPC) 40 for use as a conductor trace is mounted on the arm 32 and load beam 34a. The magnetic head 17 is electrically connected to a main FPC 21b (described later) through the relay FPC 40.

As shown in FIGS. 1 and 2, the four HGAs 30 and spacer rings are fitted on the sleeve of the bearing unit 28 that is passed through the respective through-holes of the four arm 32 and spacer rings, and are laminated along the axis of the sleeve. A positioning screw 38 is passed through positioning holes in the arms 32 from above. In this way, the arms 32 and spacer rings are relatively positioned in place with respect to the circumference of the bearing unit 28. Thus, the four arms 32 are located parallel to one another with predetermined spaces therebetween and extend in the same direction from the bearing unit 28. The two upper arms 32 are located parallel to each other with a predetermined space therebetween, and the suspensions 34 and magnetic heads 17 on the arms face one another. Further, the two lower arms 32 are located parallel to each other with a predetermined space therebetween, and the suspensions 34 and magnetic heads 17 on the arms face one another.

A support frame 43 of a synthetic resin is integrally molded on one of the spacer rings. The support frame 43 extends from the bearing unit 28 on the opposite side to the arms 32. A voice coil 41 that constitutes a part of the VCM 24 is embedded in the support frame 43.

As seen from FIG. 1, the lower end portion of the pivot of the bearing unit 28 is secured to the base 12 with the HSA 22 constructed in the above-described manner incorporated on the base 12. The bearing unit 28 stands substantially parallel to the spindle of the spindle motor 18. Each magnetic disk 16 is located between its corresponding two of the HGAs 30. When the HDD is active, the magnetic heads 17 face the upper and lower surfaces, individually, of the magnetic disk 16 and hold the disk from both sides. The voice coil 41 secured to the support frame 43 is located between a pair of yokes secured to the base 12. Thus, the voice coil, along with the yokes and a magnet (not shown) secured to one of the yokes, constitutes the VCM 24.

As shown in FIG. 1, the board unit 21 comprises a main body 21a formed of a flexible printed circuit board, which is secured to the bottom wall 12a of the base 12. Electronic components (not shown), including the preamplifier, are mounted on the main body 21a. A connector (not shown) for connection with the printed circuit board is mounted on the bottom surface of the main body 21a.

The board unit 21 comprises the main FPC 21b extending from the main body 21a. An extended end of the main FPC 21b constitutes a connecting end portion 42. As described later, the connecting end portion 42 comprises a plurality of connecting pads and is connected to the vicinity of the bearing unit 28 of the HSA 22. The relay FPC 40 of each HGA 30 is mechanically and electrically connected to the connecting end portion 42. Thus, the board unit 21 is electrically connected to each magnetic head 17 through the main FPC 21b and relay FPC 40.

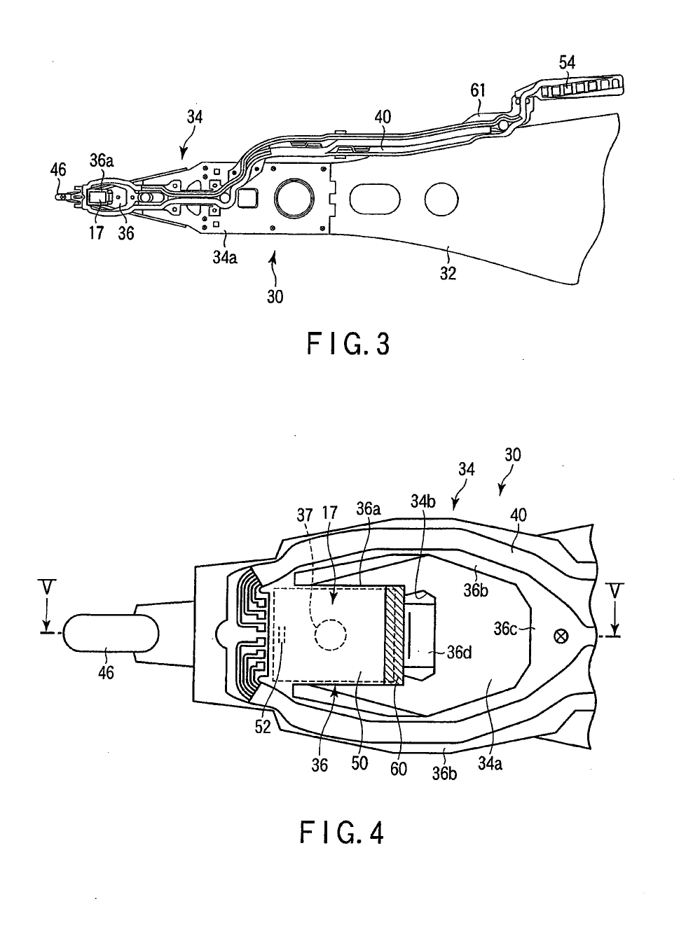

The ramp loading mechanism 25 comprises a ramp 45 (FIG. 1) and tabs 46 (FIGS. 2 and 3). The ramp 45 is disposed on the bottom wall 12a of the base 12 and located outside the magnetic disks 16. The tabs 46 extend individually from the respective distal ends of the suspensions 34. When the HSA 22 pivots around the bearing unit 28 so that the magnetic heads 17 move to the retracted position outside the disks 16, each of the tabs 46 engages with a corresponding ramp surface formed on the ramp 45 and is then impelled up the ramp to unload the heads 17. The unloaded heads 17 are held in the retracted position.

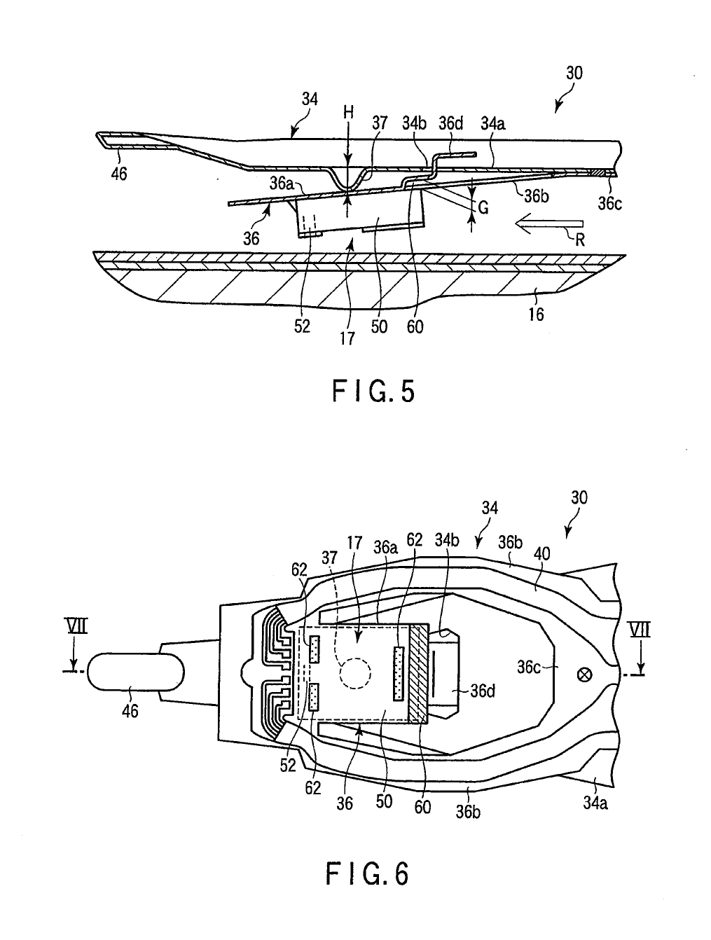

The HGA 30 will now be described in detail. FIG. 4 is an enlarged view of the distal end portion of the suspension 34 and the magnetic head, and FIG. 5 is a sectional view of the distal end portion of the suspension.

As shown in FIGS. 2 to 4, the gimbal 36 is mounted on the disk-facing side of the load beam 34a. The gimbal 36 is, for example, an elongated thin band of stainless steel. The gimbal 36 comprises a flat, rectangular head mounting portion 36a, elastic portions 36b, and band-like fixed portion 36c. The elastic portions 36b bifurcate from the head mounting portion toward the proximal end of the arm 32. The fixed portion 36c extends from the elastic portions toward the proximal end of the arm. The head mounting portion 36a faces the distal end portion of the load beam 34a with a gap therebetween and is located so that its central axis is substantially aligned with that of the load beam 34a. The elastic portions 36b extend spaced apart from each other on the opposite sides of the head mounting portion 36a. The fixed portion 36c is secured to the load beam 34a by, for example, spot welding.

The gimbal 36 comprises a limiter 36d extending from the head mounting portion 36a. The limiter 36d extends to above the load beam 34a through a through-hole 34b therein and its extended end portion faces the upper surface of the load beam with a gap therebetween. If the head mounting portion 36a moves a long distance toward the magnetic disks 16, the limiter 36d abuts the load beam 34a, thereby preventing an excessive movement of the head mounting portion 36a.

The magnetic head 17 is mounted on the head mounting portion 36a of the gimbal 36. Each magnetic head 17 comprises a substantially rectangular slider 50 and head section 52 formed on the slider. The head section 52 comprises, for example, a recording element and magnetoresistive (MR) element for reproduction. The slider 50 has a size corresponding to the head mounting portion 36a and its backside is secured to the head mounting portion 36a by, for example, adhesive bonding.

A dimple or substantially hemispheric protrusion 37, projecting on the magnetic disk side in this case, is formed at that position on the load beam 34a which faces the head mounting portion 36a of the gimbal 36, that is, the central portion of the magnetic head 17. The protrusion 37 abuts the head mounting portion 36a from behind the head 17. The head mounting portion 36a is elastically pressed against the protrusion 37 by the elasticity of the elastic portions 36b. The magnetic head 17 and the head mounting portion 36a of the gimbal 36 can be displaced in the pitch and roll directions or vertically around the protrusion 37 by elastic deformation of the elastic portions 36b. Further, the magnetic head 17 is subjected to a predetermined head load produced by the spring force of the suspension 34 and directed to the surface of the magnetic disk 16.

As shown in FIGS. 3 and 4, on the other hand, the relay FPC 40 is affixed to the inner surfaces of the arm 32 and suspension 34 and extends from the distal end of the suspension to the proximal end portion of the arm. The relay FPC 40 is in the form of an elongated band as a whole, whose distal end is electrically connected to an electrode (not shown) of the magnetic head 17. The other end portion of the relay FPC 40 extends outward from the proximal end portion of the arm 32 and constitutes a terminal area 54. Each terminal area 54 is electrically and mechanically connected to the connecting end portion 42 of the main FPC 21b. A thin metal plate (flexure) 61 of, for example, stainless steel in the form of an elongated band is formed on the reverse side of the relay FPC 40. On the side of the metal plate 61, the relay FPC 40 is affixed or pivotally welded to the arm 32 and suspension 34. The suspension-side end portion of the metal plate 61 is formed integrally with the gimbal 36.

In each HGA 30, as shown in FIGS. 4 and 5, a gap portion 60 that accommodates contamination is defined between the slider 50 and the head mounting portion 36a of the gimbal 36, in an area where the head mounting portion 36a and an inflow end of the slider 50 for airflow overlap each other. In the present embodiment, an inflow-side end portion of the head mounting portion 36a for airflow R is stepped away from the slider 50 and connects with the limiter 36d. Thus, the gap portion 60 is formed between the gimbal 36 and the inflow end of the slider 50. The gap portion 60 extends, for example, throughout the widths of the head mounting portion 36a and slider 50 and opens on the inflow-end side of the slider. The outflow-end side of the gap portion 60 is closed by the head mounting portion 36a. Height (width) G of the gap portion 60, which ranges from 10 to 50 μm, for example, is less than height T of the protrusion 37 of the load beam 34a.

When the magnetic disk 16 rotates at high speed, as shown in FIG. 5, a stagnation point where the flow rate of airflow R is approximately zero is formed near the inflow end of the slider 50. However, the position of the stagnation point moves to the gap portion 60 for use as a dust collection pocket, which is provided between the gimbal 36 and the inflow end of the slider 50. Thus, suspended contamination in the HDD moves into the gap portion 60 and is accumulated therein. The contamination accumulated in the gap portion 60 is prevented from dropping onto the magnetic disk 16 or being suspended again in the HDD.

According to the HDD constructed in this manner, each of the magnetic disks 16 is rotated at high speed when it is activated. If the voice coil 41 is energized, the HSA 22 pivots around the bearing unit 28, whereupon each magnetic head 17 is moved to and positioned on a desired track of the disk 16. The head 17 performs data processing on the disk 16, that is, writes and reads data to and from the disk.

The contamination in the HDD is carried by airflow that is produced as the magnetic disk 16 rotates. Some dust gets into and accumulates in the gap portion 60 between the gimbal 36 and the inflow end of the slider 50. The contamination or dust accumulated in the gap portion 60 remains in the gap portion 60 even during a head loading/unloading operation or other operation, so that it can be prevented from dropping onto the magnetic disk 16 or being suspended again in the HDD. Accordingly, the contamination can be prevented from permeating between the disks and heads and damaging them. Thus, the reliability of the HGA and HDD can be improved.

The following is a description of alternative embodiments of the invention.

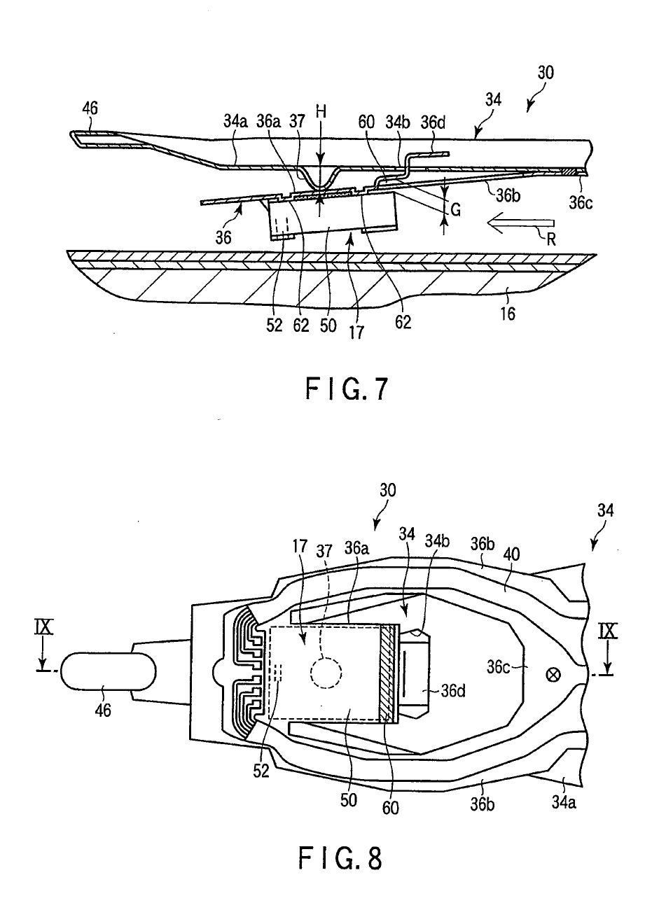

FIG. 6 is an enlarged view of a magnetic head of an HGA 30 of an HDD according to a second embodiment and its surroundings, and FIG. 7 is a sectional view of the distal end portion of the HGA taken along line VII-VII of FIG. 6. Like reference numbers are used to designate like parts in the first and second embodiments, and a detailed description of those parts is omitted.

According to the second embodiment, as shown in FIGS. 6 and 7, a plurality (e.g., three) of head support portions or bosses 62 are formed on a head mounting portion 36a of a gimbal 36, projecting on the head side so as to be flush with one another. These bosses 62 are spaced apart from one another transversely and longitudinally relative to the head mounting portion 36a. A slider 50 of a magnetic head 17 is secured to the head mounting portion 36a with its backside supported on the bosses 62. The magnetic head 17 is bonded to the head mounting portion 36a with an adhesive agent. When this is done, the adhesive agent is filled between the bosses 62 to bond the back of the slider 50 and the head mounting portion 36a.

Thereupon, the adhesive agent is prevented from leaking out by the bosses 62 and is held between the bosses.

In the HGA 30, a gap portion 60 that accommodates contamination is defined between the slider 50 and the head mounting portion 36a of the gimbal 36, in an area where the head mounting portion 36a and an inflow end of the slider 50 for airflow R overlap each other. An inflow-side end portion of the head mounting portion 36a for airflow R is stepped away from the slider 50 and connects with a limiter 36d. Thus, the gap portion 60 is formed between the gimbal 36 and the inflow end of the slider 50. The gap portion 60 extends, for example, throughout the widths of the head mounting portion 36a and slider 50 and opens on the inflow-end side of the slider. Height (width) G of the gap portion 60, which ranges from 10 to 50 μm, for example, is less than height T of a protrusion 37 of a load beam 34a and more than that of the bosses 62.

Also in the HDD according to the second embodiment constructed in this manner, contamination produced in the HDD can be trapped and accumulated in the gap portion 60 of the HGA 30, and accumulated dust or the like can be prevented from dropping onto a magnetic disk 16 or being suspended again in the HDD. Accordingly, the contamination can be prevented from permeating between the disk and head and damaging them. Thus, the reliability of the HGA and HDD can be improved.

The following is a description of an HDD according to a third embodiment.

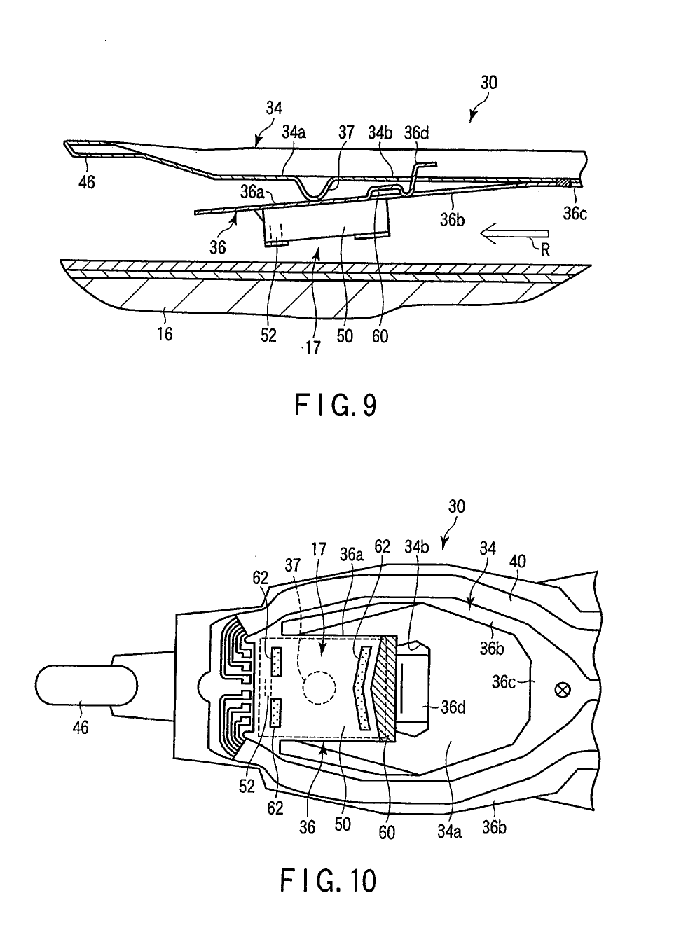

FIG. 8 is an enlarged view of a magnetic head of an HGA 30 of an HDD according to the third embodiment and its surroundings, and FIG. 9 is a sectional view of the distal end portion of the HGA taken along line IX-IX of FIG. 8. Like reference numbers are used to designate like parts in the first and third embodiments, and a detailed description of those parts is omitted.

According to the third embodiment, a gap portion 60 formed in the HGA 30 differs in configuration from that of the first embodiment. Thus, in the HGA 30, as shown in FIGS. 8 and 9, the gap portion 60 that accommodates contamination is defined between a slider 50 and a head mounting portion 36a of a gimbal 36, in an area where the head mounting portion 36a and an inflow end of the slider 50 for airflow R overlap each other. In the present embodiment, an inflow-side end portion of the head mounting portion 36a for airflow R is stepped away from the slider 50, is further stepped toward the slider 50 in a position beyond the inflow end of the slider 50, and then connects with a limiter 36d. Thus, the gap portion 60 is formed between the gimbal 36 and the inflow end of the slider 50. The gap portion 60 extends, for example, throughout the widths of the head mounting portion 36a and slider 50 and opens on the inflow-end side of the slider and toward a magnetic disk 16. The outflow-end side of the gap portion 60 is closed by the head mounting portion 36a. Height (width) G of the gap portion 60, which ranges from 10 to 50 μm, for example, is less than height T of a protrusion 37 of a load beam 34a.

Other configurations of the HDD are the same as those of the first embodiment.

Also in the HDD according to the third embodiment constructed in this manner, contamination produced in the HDD can be trapped and accumulated in the gap portion 60 of the HGA 30, and accumulated dust or the like can be prevented from dropping onto the magnetic disk 16 or being suspended again in the HDD. According to the present embodiment, the gap portion 60 is shaped so as to open toward the disk 16, so that the trapped contamination can be further prevented from being discharged. Accordingly, the contamination can be prevented from permeating between the disk and head and damaging them, so that the reliability of the HGA and HDD can be improved.

The following is a description of an HDD according to a fourth embodiment.

FIG. 10 is an enlarged view of a magnetic head of an HGA 30 of an HDD according to the fourth embodiment and its surroundings. Like reference numbers are used to designate like parts in the first, second, and fourth embodiments, and a detailed description of those parts is omitted.

According to the fourth embodiment, a gap portion 60 formed in the HGA 30 differs in shape from those of the first and second embodiments. Thus, in the HGA 30, as shown in FIG. 10, the gap portion 60 that accommodates contamination is defined between a slider 50 and a head mounting portion 36a of a gimbal 36, in an area where the head mounting portion 36a and an inflow end of the slider 50 for airflow R overlap each other. In the present embodiment, an inflow-side end portion of the head mounting portion 36a for airflow R is stepped away from the slider 50 and then connects with a limiter 36d. Thus, the gap portion 60 is formed between the gimbal 36 and the inflow end of the slider 50. The gap portion 60 extends, for example, throughout the widths of the head mounting portion 36a and slider 50 and opens on the inflow-end side of the slider and toward a magnetic disk 16. The outflow-end side of the gap portion 60 is closed by the head mounting portion 36a and tapered downstream. For example, the outflow-end side of the gap portion 60 is circular or wedge-like as illustrated. The height (width) of the gap portion 60, which ranges from 10 to 50 μm, for example, is less than that of a protrusion 37 of a load beam 34a.

Other configurations of the HDD are the same as those of the first and second embodiments.

Also in the HDD according to the fourth embodiment constructed in this manner, contamination produced in the HDD can be trapped and accumulated in the gap portion 60 of the HGA 30, and accumulated dust or the like can be prevented from dropping onto the magnetic disk 16 or being suspended again in the HDD. According to the present embodiment, the gap portion 60 is tapered downstream, so that the trapped contamination can be further prevented from being discharged. Accordingly, the contamination can be prevented from permeating between the disk and head and damaging them, so that the reliability of the HGA and HDD can be improved.

The following is a description of an HDD according to a fifth embodiment.

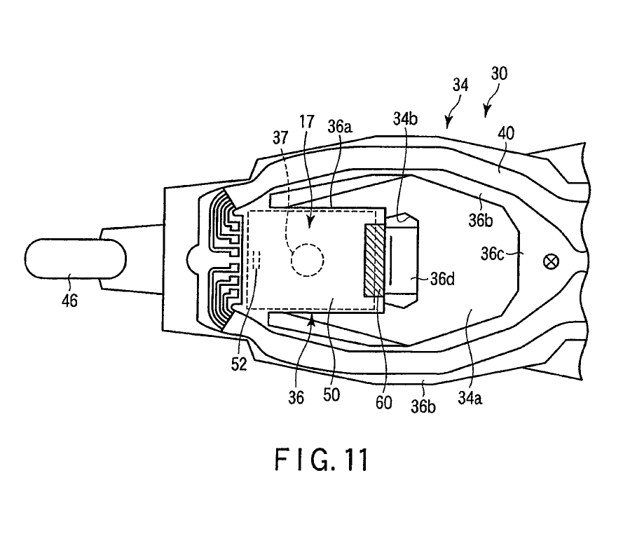

FIG. 11 is an enlarged view of a magnetic head of an HGA 30 of an HDD according to the fifth embodiment and its surroundings. Like reference numbers are used to designate like parts in the first and fifth embodiments, and a detailed description of those parts is omitted.

According to the fifth embodiment, a gap portion 60 formed in the HGA 30 differs in shape from that of the first embodiment. Thus, in the HGA 30, as shown in FIG. 11, the gap portion 60 that accommodates contamination is defined between a slider 50 and a head mounting portion 36a of a gimbal 36, in an area where the head mounting portion 36a and an inflow end of the slider 50 for airflow R overlap each other. In the present embodiment, an inflow-side end portion of the head mounting portion 36a for airflow R is stepped away from the slider 50 and then connects with a limiter 36d. Thus, the gap portion 60 is formed between the gimbal 36 and the inflow end of the slider 50. The length of the gap portion 60 transversely relative to the slider 50 is less than the width of the slider. The gap portion 60 opens toward the inflow end of the slider. The outflow-end side of the gap portion 60 is closed by the head mounting portion 36a. The height (width) of the gap portion 60, which ranges from 10 to 50 μm, for example, is less than that of a protrusion 37 of a load beam 34a.

Other configurations of the HDD are the same as those of the first embodiment.

Also in the HDD according to the fifth embodiment constructed in this manner, contamination produced in the HDD can be trapped and accumulated in the gap portion 60 of the HGA 30, and accumulated dust or the like can be prevented from dropping onto the magnetic disk 16 or being suspended again in the HDD. Accordingly, the contamination can be prevented from permeating between the disk and head and damaging them, so that the reliability of the HGA and HDD can be improved.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

The respective arms of the HGAs used in each of the embodiments described herein are independent plate-like arms. However, these arms may be replaced with a so-called E-block structure comprising a plurality of arms and a bearing sleeve that are formed integrally with one another. The magnetic disks are not limited to 2.5-inch disks and may be of other sizes. Further, the disks used are not limited to two in number and may be one or three or more. The number of HGAs may also be varied according to the number of installed disks. The shape of the gap portion of each HGA is not limited to the embodiments described herein and may be suitably modified.

What is claimed is:

1. A head gimbal assembly comprising:
a suspension comprising a load beam and a gimbal;
a slider comprising a head and mounted on the gimbal;
a gap portion defined between the gimbal and the slider, in an area where the gimbal and an air inflow end of the slider overlap each other, and configured to accommodate contamination.

2. The head gimbal assembly of claim 1, wherein the load beam comprises a protrusion configured to abut a central portion of the slider through the gimbal and a height of the gap portion is less than the projection height of the protrusion.

3. The head gimbal assembly of claim 2, wherein the gap portion extends along a width of the slider and opens on the air inflow-end side of the slider.

4. The head gimbal assembly of claim 3, wherein the gap portion extends throughout the width of the slider.

5. The head gimbal assembly of claim 3, wherein the gap portion is formed with a length less than the width of the slider.

6. The head gimbal assembly of claim 3, wherein an outflow-end side of the gap portion is closed by the gimbal and tapered toward the air outflow side.

7. The head gimbal assembly of claim 2, wherein the gap portion extends along the width of the slider, and the air inflow- and outflow-end sides are closed by the gimbal and open toward the slider.

8. The head gimbal assembly of claim 2, wherein the gimbal comprises a flat mounting portion corresponding to the slider in size, and the slider is adhesively bonded to the mounting portion.

9. The head gimbal assembly of claim 8, wherein the mounting portion of the gimbal comprises a plurality of bosses individually projecting toward the slider, the slider is supported on the bosses, and the height of the gap portion is more than a projection height of the bosses and less than the projection height of the protrusion.

10. A disk drive comprising:
a disk recording medium;
a drive motor configured to support and rotate the recording medium; and
a head stack assembly supporting a head, configured to process data on the recording medium, for movement relative to the recording medium,
the head stack assembly comprising a bearing unit and a plurality of head gimbal assemblies supported by the bearing unit,
each of the head gimbal assemblies comprising a suspension comprising a load beam and a gimbal, a slider comprising a head and mounted on the gimbal, and a gap portion defined between the gimbal and the slider, in an area where the gimbal and an air inflow end of the slider overlap each other, and configured to accommodate contamination.

11. The head gimbal assembly of claim 10, wherein the load beam comprises a protrusion configured to abut a central portion of the slider through the gimbal and a height of the gap portion is less than the projection height of the protrusion.

12. The head gimbal assembly of claim 11, wherein the gap portion extends along a width of the slider and opens on the air inflow-end side of the slider.
